(19) United States
(12) Patent Application Publication
(10) Pub. No.: US 2020/0019242 A1
(43) Pub. Date: Jan. 16, 2020

(54) DIGITAL PERSONAL EXPRESSION VIA WEARABLE DEVICE

(71) Applicant: Microsoft Technology Licensing, LLC, Redmond, WA (US)

(72) Inventors: Charlene Mary ATLAS, Redmond, WA (US); Sean Kenneth MCBETH, Bellevue, WA (US); Andrew Frederick MUEHLHAUSEN, Seattle, WA (US); Kenneth Mitchell JAKUBZAK, Lynnwood, WA (US)

(73) Assignee: Microsoft Technology Licensing, LLC, Redmond, WA (US)

(21) Appl. No.: 16/034,114

(22) Filed: Jul. 12, 2018

(51) Int. Cl. G06F 3/01; G06F 1/16; G06N 99/00; G06F 3/16

(52) U.S. Cl. CPC G06F 3/014; G06F 1/163; G06F 2203/011; G06F 3/017; G06F 3/16; G06N 99/005

(57) ABSTRACT

Examples are disclosed that relate to evoking an emotion and/or other an expression of an avatar via a gesture and/or posture sensed by a wearable device. One example provides a computing device including a logic subsystem and memory storing instructions executable by the logic subsystem to receive, from a wearable device configured to be worn on a hand of a user, an input of data indicative of one or more of a gesture and a posture. The instructions are further executable to, based on the input of data received, determine a digital personal expression corresponding to the one or more of the gesture and the posture, and output the digital personal expression.

### BACKGROUND

Effective interpersonal communication may involve interpreting non-verbal communication aspects such as facial expressions, body gestures, voice tone, and other social cues.

### SUMMARY

Examples are disclosed that relate to digitally designating an emotion and/or other personal expression via a hand-worn wearable device. One example provides a computing device comprising a logic subsystem and memory comprising instructions executable by the logic subsystem to receive, from a wearable device configured to be worn on a hand of a user, an input of data indicative of one or more of a gesture and a posture of the hand of the user. The instructions are further executable to, based on the input of data received, determine a digital personal expression corresponding to the one or more of the gesture and the posture, and output the digital personal expression.

Another example provides a wearable device configured to be worn on a hand of a user, the wearable device comprising an input subsystem including one or more sensors, a logic subsystem, and memory holding instructions executable by the logic subsystem to receive, from the input subsystem, information comprising one or more of hand pose data and/or hand motion data. The instructions are further executable to, based at least on the information received, determine a digital personal expression corresponding to the one or more of the hand pose data and/or the hand motion data, and to send the digital personal expression to an external computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B show an example use scenario in which a user performs a gesture to modify an emotional expression of a displayed avatar.

FIG. 2 shows an example use scenario in which a user actuates a mechanical input mechanism of a wearable device to modify a posture of an avatar to express an emotion.

FIGS. 3A and 3B show an example use scenario in which a user performs a gesture to store a digital personal expression associated with a speech input.

FIG. 4 shows a schematic view of an example computing environment in which a wearable device may be used to input digital personal expressions.

FIG. 5 shows a flow diagram illustrating an example method for determining a digital personal expression based upon hand tracking data received from a wearable device.

FIG. 6 shows a flow diagram illustrating an example method for controlling a digital personal expression of an avatar via a wearable device.

FIG. 7 shows a flow diagram illustrating an example method for determining a probable digital personal expression via a trained machine learning model.

FIG. 8 shows a block diagram illustrating an example computing system.

### DETAILED DESCRIPTION

Networked computing devices may be used for many different types of interpersonal communication, including conducting business conference calls, playing games, and communicating with friends and family. In these examples and others, virtual avatars may be used to digitally represent real-world persons.

Effective interpersonal communication relies upon many factors, some of which may be difficult to detect or interpret in communications over computer networks. For example, in chat applications in which users transmit messages over a network, it may be difficult to understand an emotional tone that a user wishes to convey, which may lead to misunderstanding. Similar issues may exist in voice communication. For example, a person's natural voice pattern may be mistaken by another user as an expression of an emotion not actually being felt by the person speaking. As more specific examples, high volume, high cadence speech patterns may be interpreted as anger or agitation, whereas low volume, low cadence speech patterns may be interpreted as the user being calm and understanding, even where these are neutral speech patterns and not meant to convey emotion. Facial expressions also may be misinterpreted, as a person's actual emotional state may not match an emotional state perceived by another person based on facial appearance. Similar issues may be encountered when using machine learning techniques to attribute emotional states to users based on voice characteristics and/or image data capturing facial expressions.

In view of the above issues, a user may wish to explicitly control the digital representation of emotions or other personal expressions that are presented to others (collectively referred to herein as “digital personal expressions”) in online communications so that the user can correctly attribute emotional states and other feelings to an avatar representation of the user. Various methods may be used to communicate personal expressions digitally. For example, in a video game environment, buttons on a handheld controller may be mapped to a facial or bodily animation of an avatar. However, proper selection of an intended animation may be dependent upon a user memorizing preset button/animation associations. Learning such inputs may be unintuitive and detract from natural conversational flow.

User hand gestures and/or postures may be used as a more natural and intuitive method to input a digital personal expression for conveying a user's emotion to others. As people commonly use hand gestures when communicating, the use of hand gestures to attribute emotional states to inputs of speech or other communication (e.g. game play) may allow for more natural communication flow while making the inputs, and also provide a more intuitive learning process. Various methods may be used to detect hand gestures and/or postures. For example, many computing device use environments include image sensors which, in some applications, acquire image data (depth and/or two-dimensional) of users. Such image data may be used to detect and classify hand gestures and/or postures as corresponding to specific emotional states. However, classifying hand gestures and postures (including finger gestures and postures) may be difficult, due at least in part to such issues as partial or full occlusion of one or both hands in the image data.

In view of such issues, examples are disclosed herein that relate to detecting inputs of digital personal expressions via hand gestures and/or postures made using hand-wearable devices. In some examples, a wearable device may take the form of a ring-like input device worn on a digit of a hand. In other examples, a wearable device may take the form of a glove or another article of jewelry configured to be worn on a hand. Such input devices may be worn on a single hand or both hands. Further, a user may wear rings on multiple digits of a single hand, or motion sensors may be provided on different digits of a glove, to allow gestures and/or poses of individual fingers to be resolved.

In any of these examples, while wearing the wearable device, a user may move their hands to perform gestures and/or postures recognizable by a computing device as evoking a digital personal expression. Such gestures and/or postures may be expressly mapped to digital personal expressions, or may correspond to natural conversational hand motions from which probable emotions may be detected via machine learning techniques. Where gestures and/or postures are expressly mapped to digital personal expressions, the gestures and/or postures may be predefined (e.g. alphanumeric characters recognizable by a character recognition system), or may be arbitrary and user-defined. In some examples, a user also may trigger a specific digital personal expression via a button, touch sensor, or other input mechanism on the wearable device.

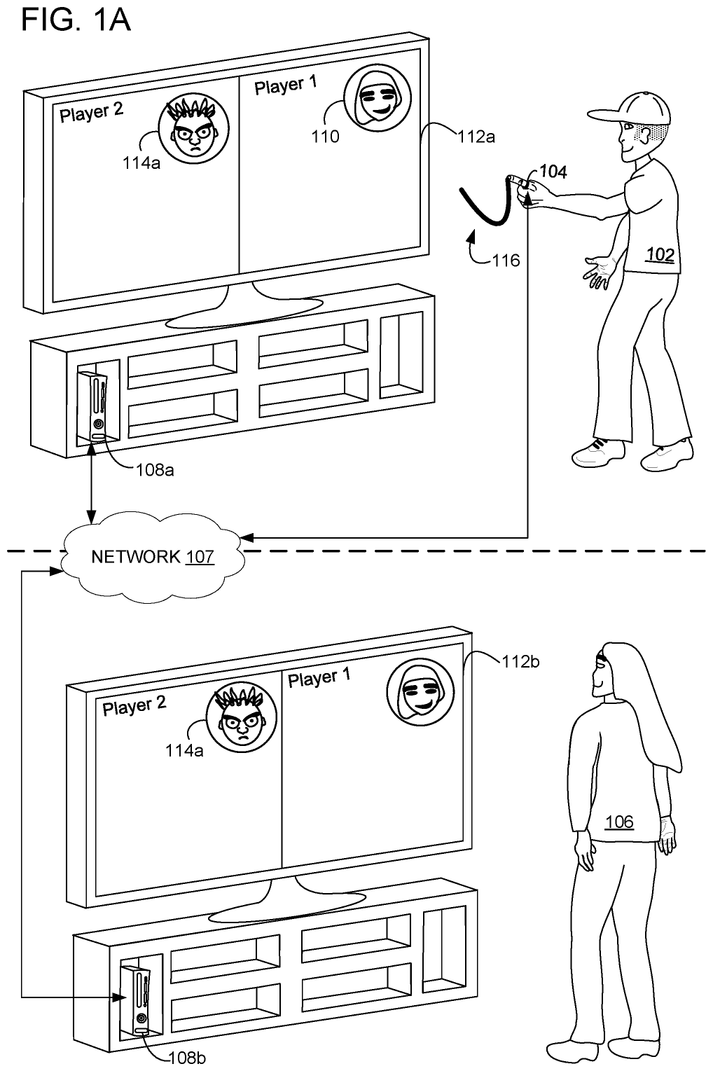

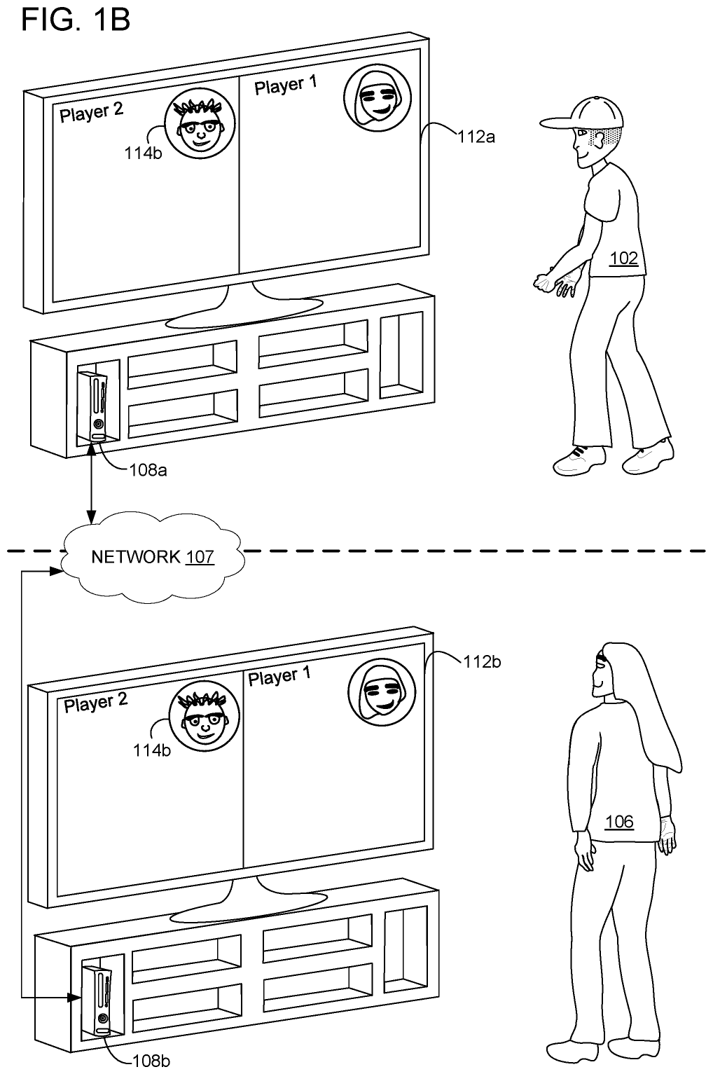

FIGS. 1A and 1B show an example use scenario 100 in which a user 102 performs a gesture while wearing a wearable device 104 on a finger to modify a facial expression of a displayed avatar to communicate desired emotional information. The user 102 (“Player 1”) is playing a video game against a remotely located acquaintance 106 (“Player 2”) via a computer network 107. An avatar representation 110 of the acquaintance 106 is displayed via the user's display 112a. In the depicted example, an avatar 114a representing the user 104 also is displayed on the user's display 112a as feedback for the user 102 to see a current appearance of avatar 114a. In FIG. 1A, the avatar 114a comprises a frowning face that may express displeasure to the acquaintance 106 (e.g. about losing a video game). However, the user 102 wishes to convey a different emotion to the acquaintance 106, and thus performs an arc-shaped gesture 116 that resembles a smile. The wearable device 104 and/or video game console 108a recognizes the arc-shaped gesture and determines a corresponding digital personal expression—happy. The digital personal expression is communicated to video game console 108b for display to user 106 as a modification of the avatar expression, and is also output by video game console 108a for display. FIG. 1B shows the avatar representation 114b of the user 102 expressing a smile in response to the arc-shaped gesture 116. Hand gesture-based inputs also may be used to express emotions and other personal digital expressions in one-to-many user scenarios. For example, a user in a conference call that uses avatars to represent participants may trace an “X” shaped gesture using a hand-worn device to express disapproval of a concept, thereby changing that user's avatar expression to one of disapproval for viewing by other participants.

Hand gestures and/or postures (including finger gestures and/or postures) may be recognized in any suitable manner. As one example, the wearable device 104 may include an inertial measurement unit (IMU) comprising one or more accelerometers, gyroscopes, and/or magnetometers to provide motion data. As another example, a wearable device may comprise a plurality of light sources trackable by an image sensor, such as an image sensor incorporated into a wearable device (e.g. a virtual reality or mixed reality head mounted display device worn by the user) or a stationary image sensor in the use environment. The light sources may be mounted to a rigid portion of the wearable device so that the light sources maintain a spatial relationship relative to one another. Image data capturing the light sources may be compared to a model of the light sources (e.g. using a rigid body transform algorithm) to determine a location and orientation of the wearable device relative to the image sensor. In either of these examples, the motion data determined may be analyzed by a classifier function (e.g. a decision tree, neural network, or other suitable trained machine learning function) to identify gestures. For example, three-dimensional motion sensed by the IMU on the wearable device may be computationally projected onto a two-dimensional virtual plane to form symbols on the plane, which may then be analyzed via character recognition. Further, to facilitate gesture and/or posture recognition, a user may hold a button or touch a touch sensor on the wearable device for a duration of the gesture and/or posture, thereby specifying the motion data sample to analyze.

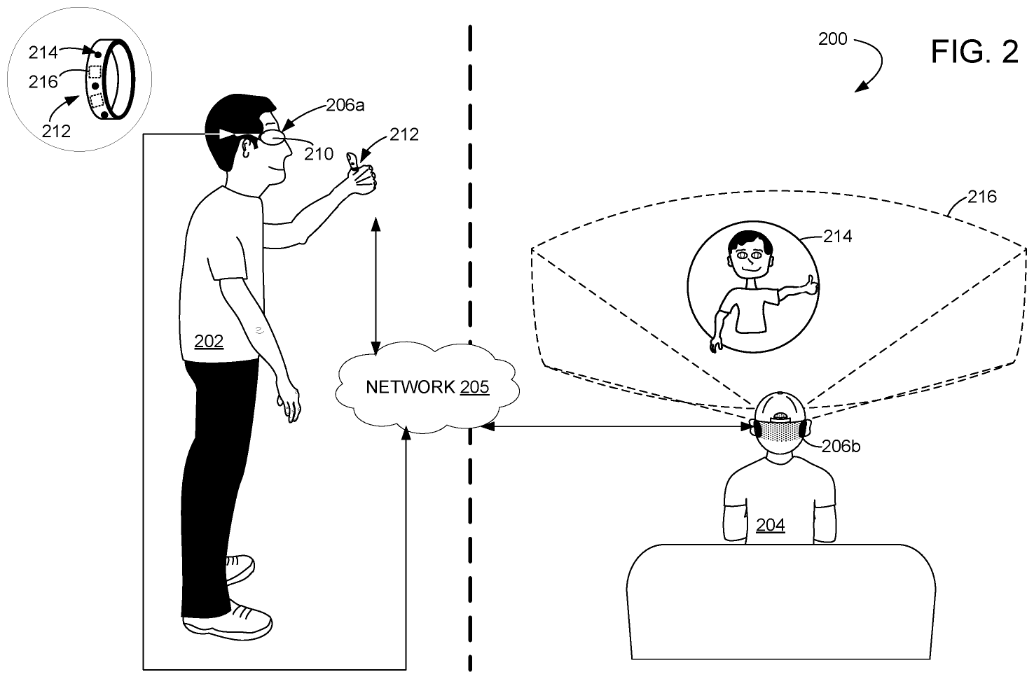

As mentioned above, in addition to hand gestures and/or pose tracked via motion sensing, a wearable device may include one or more user-selectable input devices (e.g. mechanical actuator(s) and/or touch sensor(s)) actuatable to trigger the output of a specific digital personal expression. FIG. 2 depicts an example use scenario 200 in which user 202 and user 204 are communicating over a computer network 205 via near-eye display devices 206a and 206b, which may be virtual or mixed reality display devices. Each near-eye display device 206a and 206b comprises a display (one of which is shown at 210) configured to display virtual imagery in the field of view of a wearer, such as an avatar representing the other user. User 202 depresses a button 214 or a touch-sensitive surface 216 of the wearable device 212. The wearable device 212 recognizes the input mechanism as invoking a thumbs-up expression (e.g. via a mapping of the input to the specific gesture) and sends this digital personal expression to near-eye display device 206b for output via avatar 214, which represents user 202.

Digital personal expressions may take other forms than avatar facial expressions or body gestures. For example, hand gestures and/or postures may be mapped to physical appearances of an avatar (e.g., clothing, hairstyle, accessories, etc.).

Further, in some examples, hand gestures and/or postures may be mapped to speech characteristics. In such examples, a gesture and/or posture input may be used to control an emotional characteristic of a later presentation of a user input by a speech output system, e.g. to provide information of a current emotional state of the user providing the user input. As described above, a user may have natural, neutral speech characteristics that can be misinterpreted by a speech input system that is trained to recognize emotional information in voices across a population generally. Thus, the user may use a hand gesture and/or posture input to signify an actual current emotional state to avoid misattribution of an emotional state. Likewise, a user may wish for a message to be delivered with a different emotional tone than that used when inputting the message via speech. In this instance, the user may use a hand gesture and/or pose input to store with the message the desired emotional expression for a virtual assistant to use when outputting the message.

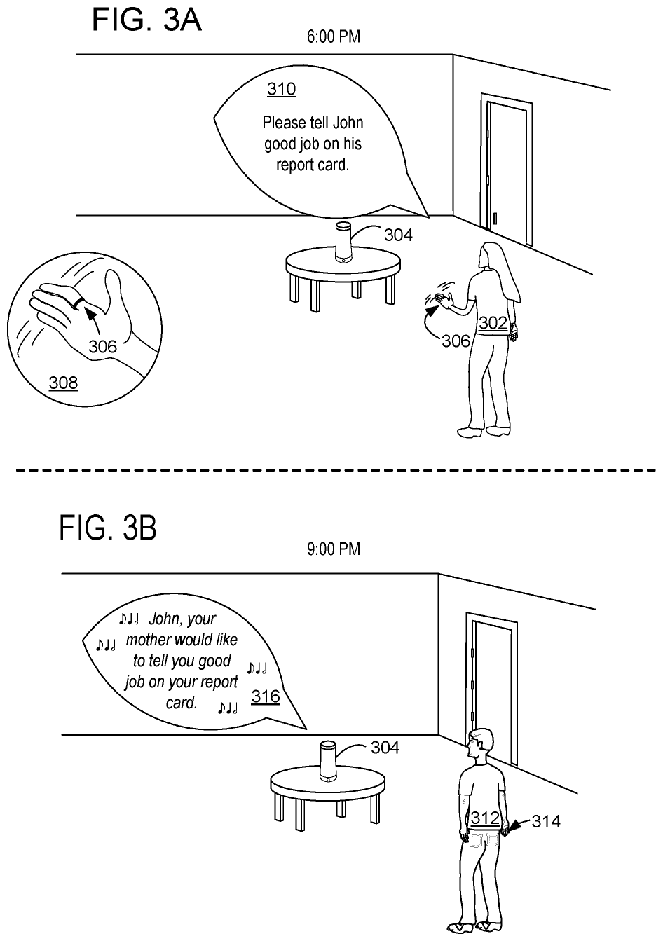

FIG. 3A depicts an example scenario in which a user 302 speaks to a virtual assistant via a “headless” computing device 304 (e.g., a smart speaker without a display) regarding her child's report card. In addition to verbally stating “please tell John good job on his report card”, the user 302 waves a hand on which she wears a wearable device 306 (shown as a ring in view 308). The wearable device 306 and/or the headless device 304 recognize(s) the waving gesture to indicate a desired enthusiastic delivery of the message, and thus stores the attributed state of enthusiasm with the user's speech input 310.

FIG. 3B depicts, at a later time, user 302's child 312 listening to the previously input message being delivered by the virtual assistant via the headless computing device 304. In this example, the virtual assistant acts as an avatar of user 302. Based upon the personal digital expression input by user 302 along with the speech input of the message, the virtual assistant delivers the message in an upbeat, enthusiastic voice, as illustrated by musical notes in FIG. 3B.

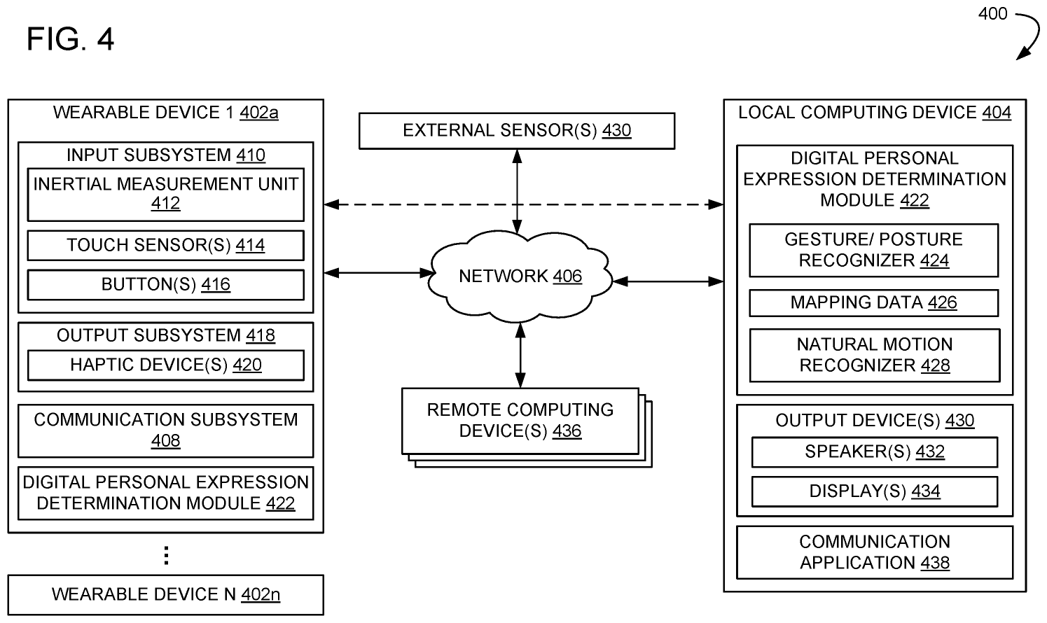

FIG. 4 schematically shows an example computing environment 400 in which one or more wearable devices 402a-402n may be used to input digital personal expressions into a computing device, shown as local computing device 404, configured to receive inputs from the wearable device(s). Wearable devices 402a through 402n may represent, for example, one or more wearable devices worn by a single user (e.g., a ring on a digit, multiple rings worn on different fingers, a glove on each hand, etc.), as well as wearable devices worn by different users of the local computing device 404. Wearable devices 402a through 402n may communicate with the local computing device 404 directly (e.g. by a direct wireless connection such as Bluetooth) and/or via a network connection 406 (e.g. via Wi-Fi) to provide digital personal expression data. The data may be provided in the form of raw sensor data, processed sensor data (e.g. identified gestures, confidence scores for identified gestures, etc.), and/or as specified personal digital expressions (e.g. specified emotions) based upon the sensor data. Each wearable device may take the form of a ring, glove, or other suitable hand-wearable object. Likewise, the local computing device may take any suitable form, such as a desktop or laptop computer, tablet computer, video game console, head-mounted computing device, or headless computing device.

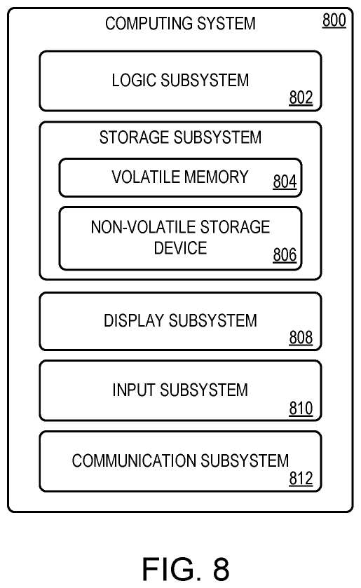

Each wearable device comprises a communication subsystem 408 configured to communicate wirelessly with the local computing device 404. Any suitable communication protocol may be used, including Bluetooth and Wi-Fi. Additional detail regarding communication subsystem 408 is described below with reference to FIG. 8.

Each wearable device 402a through 402n further comprises an input subsystem 410 including one or more input devices. Each wearable device may include any suitable input device(s), such as one or more IMUs 412, touch sensor(s) 414, and/or button(s) 416. Other input devices alternatively or additionally may be included. Examples include a microphone, image sensor, galvanic skin response sensor, and/or pulse sensor.

Each of wearable devices 402a through 402n further may comprise an output subsystem 418 comprising one or more output devices, such as one or more haptic actuators 420 configured to provide haptic feedback (e.g. vibration). The output subsystem 418 may additionally or alternatively comprise other devices, such as a speaker, a light, and/or a display.

Each wearable device 402a through 402n further may comprise other components not shown in FIG. 4. For example, each wearable device comprises a power supply, such as one or more batteries. In some examples, the wearable devices 402a through 402n use low-power computing processes to preserve battery power during use. Further, the power supply of each wearable device may be rechargeable between uses and/or replaceable.

The local computing device 404 comprises a digital personal expression determination module 422 configured to determine a digital personal expression based on gesture and/or posture data received from wearable device(s). Aspects of the digital personal expression module 422 also may be implemented on the wearable device(s), as shown in FIG. 4, on a cloud-based service, and/or distributed across such devices.

In some examples, the digital personal expression determination module 422 detects inputs of digital personal expressions based upon pre-defined mappings or user-defined mappings of gestures to corresponding digital personal expressions. As such, the digital personal expression determination module 422 may include a gesture/posture recognizer 424 configured to recognize, based on information received from a wearable device 402a, a hand gesture and/or a posture performed by a user. Any suitable recognition technique may be used. In some examples, the gesture/posture recognizer 424 may use machine learning techniques to identify shapes, such as characters, traced by a user of a wearable device as sensed by motion sensors. In some such examples, a character recognition computer vision API (application programming interface) may be used to recognize such shapes. In such examples, three-dimensional motion data may be computationally projected onto a two-dimensional plane to obtain suitable data for character recognition analysis. In other examples, the gesture/posture recognizer 424 may be trained to recognize arbitrary user-defined gestures and/or postures, rather than pre-defined gestures and/or postures. Such user-defined gestures and/or postures may be personal to a user, and thus stored in a user profile for that user. Computer vision machine learning technology may be used to train the gesture/posture recognizer 424 to recognize any suitable symbol. In other examples, information regarding an instantaneous user input device state (e.g. information that a button is in a pressed state) may be provided by the wearable device. In any of these instances, digital personal expression determination module 422 may then compare the gesture and/or posture to stored mapping data 426 to determine a corresponding digital emotional expression mapped to the determined gesture and/or posture.

In other examples, instead of or in addition to utilizing mapping data 426 to determine a digital personal expression associated with a detected gesture and/or posture, one or more trained machine learning functions may be used to infer a probable user emotional state from motion data capturing a user's natural hand motion. As such, the local computing device (and/or the wearable device(s)) further may comprise a natural motion recognizer 428 including one or more trained machine learning model(s) configured to obtain, based on features of user's natural motion, a probable digital personal expression for the user. In such an example, an input of a feature vector comprising currently observed user signal features (e.g., acceleration, position, orientation, etc. of a hand) may result in the output of a determination of a probability that a user is intending to express a given digital emotional expression based upon the current user signal features. Such a model may be trained using training data representative of population of users, for example, to understand a consensus of hand motions that generally correspond to certain digital personal expressions. As different users from different regions of the world may use different hand motions to imply different expressions, a localized training approach may also be used, wherein training data representative of a cohort of users is input into the model as ground truth. Further, once trained, a trained machine learning model may be further refined for a particular user based upon ongoing training with the user. This may comprise receiving user feedback regarding whether a probable digital personal expression obtained was a correct digital personal expression and inputting the feedback as training data for the trained machine learning model.

Any suitable methods may be used to train such a machine learning model. In some examples, a supervised training approach may be used in which gesture and/or posture data having a known outcome based upon know user signal features has been labeled with the outcome and used for training. In some such examples, training data may be observed during use and labeled based upon user a posture and/or gesture at the time of observation. Supervised machine learning may use any suitable classifier, including decision trees, random forests, support vector machines, and/or neural networks.

Unsupervised machine learning also may be used, in which user signals may be received as unlabeled data, and patterns are learned over time. Suitable unsupervised machine learning algorithms may include K-means clustering models, Gaussian models, and principal component analysis models, among others. Such approaches may produce, for example, a cluster, a manifold, or a graph that may be used to make predictions related to contexts in which a user may wish to convey a certain digital personal expression based upon features in current user signals.

Continuing with FIG. 4, the local computing device 404 may comprise one or more output devices 430, such as a speaker(s) 432 and/or a display(s) 434, for outputting a digital personal expression. It will be understood that the remote computing device(s) 436 may include any suitable hardware and may execute any of the processes described herein with reference to the local computing device 404.

The local computing device 404 further comprises a communication application 438. Communication application 438 may permit communication between users of local computing device 404 and users of remote computing device(s) 436 via a network connection, and/or may permit communication between different users of local computing device 404 (e.g., multiple users that share a smart speaker device). Example communication applications include games, social media applications, virtual assistants, meeting and/or conference applications, video calling applications, and/or text messaging applications.

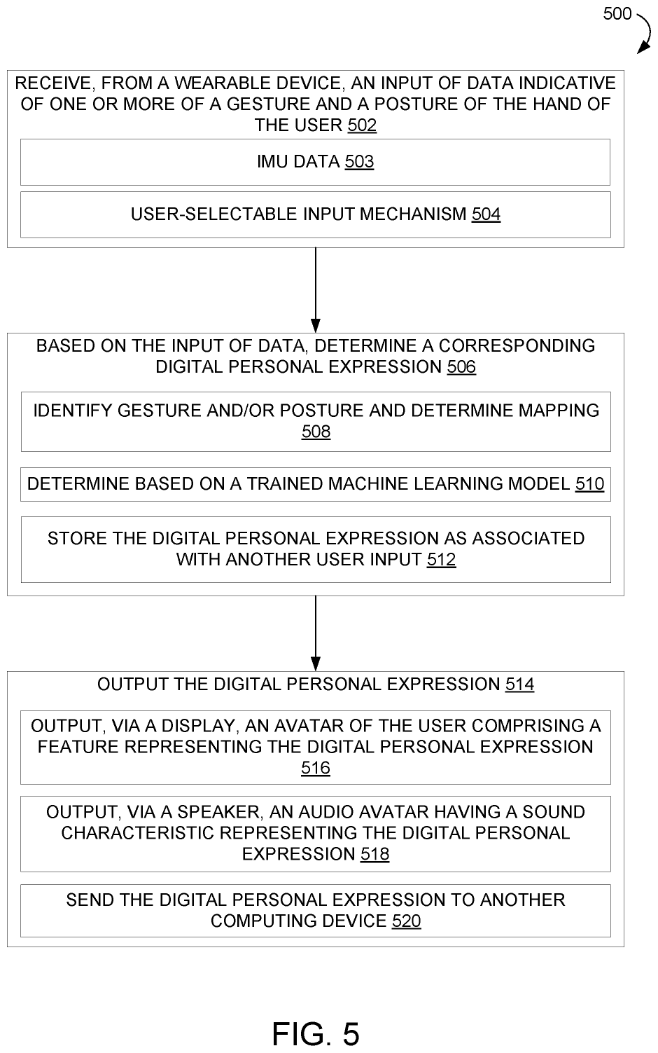

As described above, in some examples a local computing device may determine a digital personal expression based upon motion sensor information received from a wearable device. FIG. 5 illustrates an example method 500 for determining a digital personal expression based upon information received from a wearable device. Method 500 may be implemented as stored instructions executable by a logic subsystem of a computing device in communication with the wearable device.

At 502, method 500 comprises receiving, from a wearable device configured to be worn on a hand of a user, an input of data indicative of one or more of a gesture and a posture of the hand of the user. Any suitable data may be received. Examples include inertial measurement unit (IMU) data 503 such as raw motion sensor data, processed sensor data (e.g. data describing a path of the wearable device as a function of time in two or three dimensions), a determined gesture and/or posture, and/or data representing actuation of a user-selectable input device 504 of the wearable device.

Based on the input of data received, method 500 comprises, at 506, determining a digital personal expression corresponding to the one or more of the gesture and the posture. The digital personal expression may be determined in any suitable manner. In examples where motion data, but not an identified gesture or posture, is received from the wearable device, a gesture and/or posture likely represented by the motion data may be determined using a classifier function, and then a mapping of the determined gesture and/or posture to a corresponding digital personal expression may be determined, as indicated at 508. The gesture and/or posture may be a pre-defined, known gesture and/or posture (e.g. an alphanumeric symbol), or may be an arbitrary user-defined gesture and/or posture. In some such examples, a user may hold or otherwise actuate an input device on the wearable device to indicate an intent to perform an input of a digital personal expression. In other examples, the digital personal expression may be determined probabilistically based on natural conversational hand motion using a trained machine learning model, as indicated at 510.

In some examples, method 500 may comprise, at 512, storing the digital personal expression as associated with another user input, such as video, speech, image, and/or text. In this manner, an emotion or other personal expression associated with other input may be properly conveyed when the other input is later presented.

Continuing, at 514, method 500 comprises outputting the digital personal expression. The digital personal expression may be output in any suitable manner. For example, outputting the digital personal expression may comprise, at 516, outputting, via a display, an avatar of the user that comprises a feature representing the digital personal expression. Example features include a facial expression representing emotion, a modified stylistic characteristic (clothing, jewelry, hair style, etc.), a modified size and/or shape, and/or other visual representations of the digital personal expression. As another example, outputting the digital personal expression may comprise, at 518, outputting, via a speaker, an audio avatar having a sound characteristic representative of the digital personal expression, such as a modified inflection, tone, cadence, volume, and/or rhythm. As another example, outputting the digital personal expression comprises, at 520, sending the digital personal expression to another computing device. In such examples, the digital personal expression may be presented to another person by the receiving computing device.

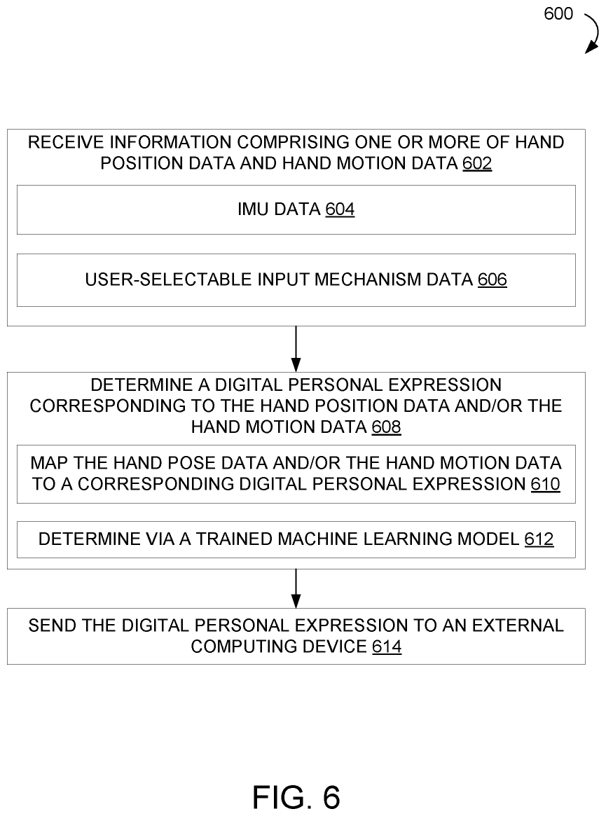

In other examples, the determination of a digital personal expression may be performed on the wearable device itself. FIG. 6 shows a flowchart illustrating an example method 600 for controlling a digital personal expression on a wearable device. Method 600 may be implemented as stored instructions executable by a logic subsystem of a wearable device, such as wearable devices 104, 212, 306, and/or 402a through 402n.

At 602, method 600 comprises sensing one or more of hand position data and hand motion data. In some examples, inertial motion sensors may be used to sense the input, as indicated at 604. In some such examples, a user may press a button or select another suitable input device to indicate the intent to make a posture and/or gesture input, and may hold the button press or other input for the duration of the posture and/or gesture, thereby indicating the data sample to analyze for gesture recognition. In other such examples, motion sensing may be performed continuously to identify probable emotional data or other personal expression data from natural conversational hand motion using machine learning techniques. In yet other examples, the hand motion and/or position data may take the form of an instantaneous state of a user-selectable input device, such as a button, touch sensor, and/or other user-selectable input mechanism, as indicated at 606.

Based at least on the information received, method 600 comprises, at 608, determining a digital personal expression corresponding to the hand pose and/or motion data. Suitable methods for determining a digital personal expression include determining a gesture and/or posture corresponding to the hand position and/or motion data and then determining a mapping of the gesture and/or posture to an expression, as indicated at 610, and/or using a trained machine learning model to determine a probable personal digital expression from natural conversational hand motion, as indicated at 612, as described above with regard to FIGS. 4 and 5. At 614, method 600 comprises sending the digital personal expression to an external computing device (e.g., a local computing device and/or a remote computing device(s)).

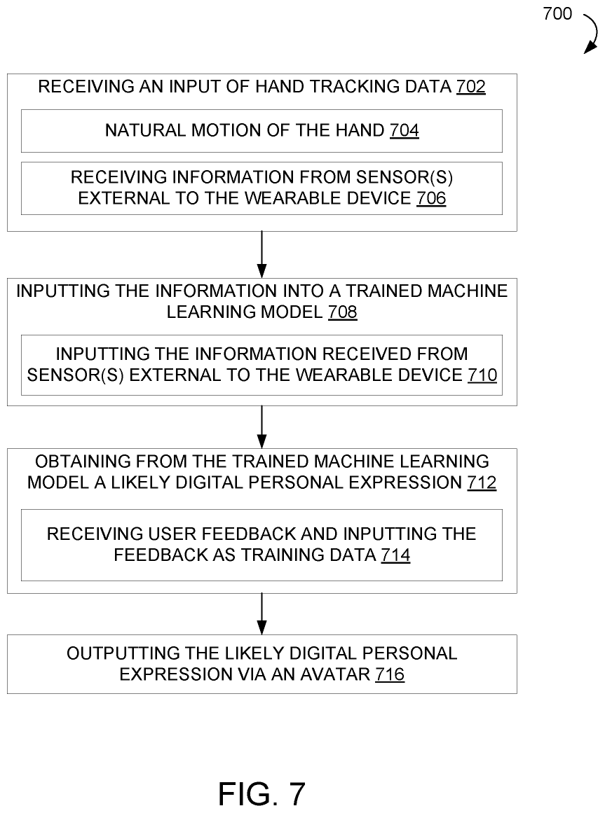

As described above, in some examples a trained machine learning model may be used to determine a digital personal expression corresponding to natural conversational hand motions. FIG. 7 shows a flow diagram illustrating an example method 700 for determining a probable digital personal expression via analysis of natural conversational hand motions via a trained machine learning model. Method 700 may be implemented as stored instructions executable by a logic subsystem of a computing device, such as those described herein.

At 702, method 700 comprises receiving an input of hand tracking data. The hand tracking data may be received from a wearable device (e.g. from an IMU on the wearable device), and/or from another device that is tracking the wearable device (e.g. an image sensing device tracking a plurality of light sources on a rigid portion of the wearable device), as indicated at 706. The information received further may comprise other sensor data from the wearable device, such as pulse data, galvanic skin response data, etc. that also may be indicative of an emotional state. Supplemental information regarding a user's current state may additionally or alternatively be received from sensors residing elsewhere in an environment of the wearable device, such as an image sensor (e.g., a depth camera and/or a two-dimensional camera) and/or a microphone.

At 708, method 700 comprises inputting the information into a trained machine learning model. For example, position and/or motion data features may be extracted from the hand tracking information received and used to form a feature vector, which may be input into the trained machine learning model. When supplemental information is received from sensor(s) external to the wearable device, such information also may be incorporated into the feature vector, as indicated at 710.

At 712, method 700 comprises obtaining from the trained machine learning model a probable digital personal expression. The probable digital personal expression obtained may comprise the most probable digital personal expression as determined from the trained machine learning model. Method 700 also may comprise, at 714, receiving user feedback regarding whether the probable digital personal expression obtained was a correct digital personal expression, and inputting the feedback as additional training data. In this manner, feedback may be used to tailor a machine learning model to individual users. At 716, method 700 comprises outputting the probable digital personal expression, as described in more detail above.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 8 schematically shows a non-limiting embodiment of a computing system 800 that can enact one or more of the methods and processes described above. Computing system 800 is shown in simplified form. Computing system 800 may embody the wearable devices 402a through 402n, the local computing device 404, and/or the remote computing device(s) 436 described above and illustrated in FIG. 4. Computing system 800 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted virtual, augmented, and/or mixed reality devices.

Computing system 800 includes a logic subsystem 802, volatile memory 804, and a non-volatile storage device 806. Computing system 800 may optionally include a display subsystem 808, input subsystem 810, communication subsystem 812, and/or other components not shown in FIG. 8.

Logic subsystem 802 includes one or more physical devices configured to execute instructions. For example, the logic subsystem may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more physical processors (hardware) configured to execute software instructions. Additionally or alternatively, the logic subsystem may include one or more hardware logic circuits or firmware devices configured to execute hardware-implemented logic or firmware instructions. Processors of the logic subsystem 802 may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration. In such a case, it will be understood that these virtualized aspects are run on different physical logic processors of various different machines.

Non-volatile storage device 806 includes one or more physical devices configured to hold instructions executable by the logic processors to implement the methods and processes described herein. When such methods and processes are implemented, the state of non-volatile storage device 806 may be transformed—e.g., to hold different data.

Non-volatile storage device 806 may include physical devices that are removable and/or built-in. Non-volatile storage device 806 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 806 may include nonvolatile, dynamic, static, read/write, read-only, sequential-access, location-addressable, file-addressable, and/or content-addressable devices. It will be appreciated that non-volatile storage device 806 is configured to hold instructions even when power is cut to the non-volatile storage device 806.

Volatile memory 804 may include physical devices that include random access memory. Volatile memory 804 is typically utilized by logic subsystem 802 to temporarily store information during processing of software instructions. It will be appreciated that volatile memory 804 typically does not continue to store instructions when power is cut to the volatile memory 804.

Aspects of logic subsystem 802, volatile memory 804, and non-volatile storage device 806 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” and “program” may be used to describe an aspect of computing system 800 typically implemented in software by a processor to perform a particular function using portions of volatile memory, which function involves transformative processing that specially configures the processor to perform the function. Thus, a module and/or program may be instantiated via logic subsystem 802 executing instructions held by non-volatile storage device 806, using portions of volatile memory 804. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and “program” may encompass individual or groups of executable files, data files, libraries, drivers, scripts, database records, etc.

When included, display subsystem 808 may be used to present a visual representation of data held by non-volatile storage device 806. The visual representation may take the form of a graphical user interface (GUI). As the herein described methods and processes change the data held by the non-volatile storage device, and thus transform the state of the non-volatile storage device, the state of display subsystem 808 may likewise be transformed to visually represent changes in the underlying data. Display subsystem 808 may include one or more display devices utilizing virtually any type of technology. Such display devices may be combined with logic subsystem 802, volatile memory 804, and/or non-volatile storage device 806 in a shared enclosure, or such display devices may be peripheral display devices.

When included, input subsystem 810 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 812 may be configured to communicatively couple various computing devices described herein with each other, and with other devices. Communication subsystem 812 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 800 to send and/or receive messages to and/or from other devices via a network such as the Internet.

Another example provides a computing device, comprising a logic subsystem and memory comprising instructions executable by the logic subsystem to receive, from a wearable device configured to be worn on a hand of a user, an input of data indicative of one or more of a gesture and a posture of the hand of the user, based on the input of data received, determine a digital personal expression corresponding to the one or more of the gesture and the posture, and output the digital personal expression. In such an example, the instructions may additionally or alternatively be executable to output, via a display, an avatar of the user, the avatar of the user comprising a feature representing the digital personal expression. In such an example, the instructions may additionally or alternatively be executable to store the digital personal expression as associated with an input of one or more of a video, a speech, an image, and/or a text. In such an example, the instructions may additionally or alternatively be executable to output the digital personal expression by sending the digital personal expression to another computing device. In such an example, the wearable device may additionally or alternatively comprise one or more of a ring and a glove. In such an example, the instructions may additionally or alternatively be executable to output, via a speaker, an audio avatar having a sound characteristic representative of the digital personal expression. In such an example, receiving the input of data indicative of the one or more of the gesture and the posture may additionally or alternatively comprise receiving data indicative of an input received by a user-selectable input mechanism of the wearable device. In such an example, the instructions may additionally or alternatively be executable to determine the digital personal expression based on a trained machine learning model. In such an example, the instructions may additionally or alternatively be executable to determine the digital personal expression based on a mapping of the one or more of the gesture and/posture to a corresponding digital personal expression.

Another example provides a wearable device configured to be worn on a hand of a user, the wearable device comprising an input subsystem comprising one or more sensors, a logic subsystem, and memory holding instructions executable by the logic subsystem to receive, from the input subsystem, information comprising one or more of hand pose data and/or hand motion data, based at least on the information received, determine a digital personal expression corresponding to the one or more of the hand pose data and/or the hand motion data, and send, to an external computing device, the digital personal expression. In such an example, the one or more sensors may additionally or alternatively comprise one or more of a gyroscope, an accelerometer, and/or a magnetometer. In such an example, the instructions may additionally or alternatively be executable to determine the digital personal expression based on mapping the one or more of the hand pose data and/or the hand motion data received to a corresponding digital personal expression. In such an example, the instructions may additionally or alternatively be executable to determine the digital personal expression via a trained machine learning model. In such an example, the wearable device may additionally or alternatively comprise one or more of a ring and a glove. In such an example, the instructions may additionally or alternatively be executable to receive a user input mapping a selected gesture and/or a selected posture to a corresponding digital personal expression. In such an example, the input subsystem may additionally or alternatively comprise one or more of a button and/or a touch sensor, and the information comprising the one or more of the hand pose data and/or the hand motion data may additionally or alternatively comprise an input received via the one or more of the button and/or the touch sensor.

Another example provides a method for designating a digital personal expression to data, the method comprising receiving, from a wearable device worn on a hand of a user, an input of information, the information comprising hand tracking data, inputting the information received into a trained machine learning model, obtaining from the trained machine learning model a probable digital personal expression corresponding to one or more of a sensed pose and/or a sensed movement of the hand, and outputting the probable digital personal expression via an avatar. In such an example, the hand tracking data may additionally or alternatively comprise data capturing natural conversational motion of the hand. In such an example, the method may additionally or alternatively comprise receiving user feedback regarding whether the probable digital personal expression obtained was a correct digital personal expression, and inputting the feedback as training data for the trained machine learning model. In such an example, the trained machine learning model may additionally or alternatively be trained based upon data obtained from one or more of a cohort comprising the user and/or a population of users.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a logic subsystem; and
memory comprising instructions executable by the logic subsystem to
receive an input;
receive, from a wearable device configured to be worn on a hand of a user, an input of data indicative of one or more of a gesture and a posture of the hand of the user;
based on the input of data received, determine a digital personal expression corresponding to the one or more of the gesture and the posture;
store the digital personal expression determined as associated with the input; and
output the digital personal expression.

2. The computing device of claim 1, wherein the instructions are executable to output, via a display, an avatar of the user, the avatar of the user comprising a feature representing the digital personal expression.

3. The computing device of claim 1, wherein the input comprises an input of one or more of a video, a speech, an image, and/or a text.

4. The computing device of claim 1, wherein the instructions are executable to output the digital personal expression by sending the digital personal expression to another computing device.

5. The computing device of claim 1, wherein the wearable device comprises one or more of a ring and a glove.

6. The computing device of claim 1, wherein the instructions are executable to output, via a speaker, an audio avatar having a sound characteristic representative of the digital personal expression.

7. The computing device of claim 1, wherein receiving the input of data indicative of the one or more of the gesture and the posture comprises receiving data indicative of an input received by a user-selectable input mechanism of the wearable device.

8. The computing device of claim 1, wherein the instructions are executable to determine the digital personal expression based on a trained machine learning model.

9. The computing device of claim 1, wherein the instructions are executable to determine the digital personal expression based on a mapping of the one or more of the gesture and/posture to a corresponding digital personal expression.

10. A wearable device configured to be worn on a hand of a user, the wearable device comprising:
an input subsystem comprising one or more sensors;
a logic subsystem; and
memory holding instructions executable by the logic subsystem to
receive, from the input subsystem, information comprising one or more of hand pose data and/or hand motion data;
based at least on the information received, determine a digital personal expression corresponding to the one or more of the hand pose data and/or the hand motion data; and
send, to an external computing device, the digital personal expression.

11. The wearable device of claim 10, wherein the one or more sensors comprises one or more of a gyroscope, an accelerometer, and/or a magnetometer.

12. The wearable device of claim 10, wherein the instructions are executable to determine the digital personal expression based on mapping the one or more of the hand pose data and/or the hand motion data received to a corresponding digital personal expression.

13. The wearable device of claim 10, wherein the instructions are executable to determine the digital personal expression via a trained machine learning model.

14. The wearable device of claim 10, wherein the wearable device comprises one or more of a ring and a glove.

15. The wearable device of claim 10, wherein the instructions are executable to receive a user input mapping a selected gesture and/or a selected posture to a corresponding digital personal expression.

16. The wearable device of claim 10, wherein the input subsystem comprises one or more of a button and/or a touch sensor, and wherein the information comprising the one or more of the hand pose data and/or the hand motion data comprises an input received via the one or more of the button and/or the touch sensor.

17. A method for designating a digital personal expression to data, the method comprising:
receiving an input;
receiving, from a wearable device worn on a hand of a user, an input of information, the information comprising hand tracking data;
inputting the information received into a trained machine learning model;
obtaining from the trained machine learning model a probable digital personal expression corresponding to one or more of a sensed pose and/or a sensed movement of the hand;
storing the probable digital personal expression as associated with the input; and
outputting the probable digital personal expression via an avatar.

18. The method of claim 17, wherein the hand tracking data comprises data capturing natural conversational motion of the hand.

19. The method of claim 17, further comprising receiving user feedback regarding whether the probable digital personal expression obtained was a correct digital personal expression, and inputting the feedback as training data for the trained machine learning model.

20. The method of claim 17, wherein the trained machine learning model is trained based upon data obtained from one or more of a cohort comprising the user and/or a population of users.
